(19) United States
(12) Patent Application Publication
(10) Pub. No.: US 2024/0396183 A1
(43) Pub. Date: Nov. 28, 2024

(54) Secondary Battery and Electric Device

(71) Applicant: JIANGSU ZENERGY BATTERY TECHNOLOGIES CO., LTD., Suzhou City (CN)

(72) Inventors: Pan XU, Suzhou City (CN); Senji FANG, Suzhou City (CN)

(21) Appl. No.: 18/671,715

(22) Filed: May 22, 2024

(30) Foreign Application Priority Data
May 22, 2023 (CN) 202321243823.8

(51) Int. Cl. H01M 50/536; H01M 10/0525; H01M 10/0587; H01M 50/533

(52) U.S. Cl. CPC H01M 50/536; H01M 10/0525; H01M 10/0587; H01M 50/533

(57) ABSTRACT

The present disclosure belongs to the technical field of secondary batteries, and in particular, to a secondary battery and an electric device. The secondary battery includes a cell and a connecting member; the cell includes a cell body, a first tab led out along one end of the cell body, and a second tab led out along the other end of the cell body; and the connecting member is sleeved on the first tab and/or the second tab. The secondary battery of the present disclosure is provided with a connecting member, the connecting member is provided with a side surface welding portion, the side surface welding portion is attached to a side edge of the first tab and/or the second tab; and since the welding direction is a horizontal direction, a cell in a vertical direction is avoided, thereby preventing a failure of the cell.

### CROSS-REFERENCE TO RELATED APPLICATIONS

The present invention claims priority to and the benefit of Chinese Patent Application No. 202321243823.8, filed with the China National Intellectual Property Administration on May 22, 2023, which is hereby incorporated by reference in its entirety.

### TECHNICAL FIELD

The disclosure belongs to the technical field of secondary batteries, and in particular, to a secondary battery and an electric device.

### BACKGROUND OF THE INVENTION

Since a large cylindrical battery has advantages in high-power discharge, fast charging and energy density, many head companies start to deploy same, and it is expected that in the future, the large cylindrical cell may be widely used in important industries such as electric vehicles and energy storage devices.

Through the development of recent years, with gradual maturity of quality and process, the performance of the battery is able to basically meet customer requirements, but the current process still has safety risks.

Currently, a cell of the large cylindrical battery adopts a whole-tab flattening process, a connecting member is placed on the end face of the cell, and then from the direction where a tab is drawn out, weld the connecting member and the tab together, which easily causes welding penetration of the connecting member, and even welding penetration of the tab, resulting in a failure of the cell, having a great safety risk.

### SUMMARY OF THE INVENTION

Some embodiments of the present disclosure are to provide a secondary battery, which may avoid welding penetration when a connecting member is welded with an electrode plate, thereby avoiding a failure of a cell.

In an embodiment of the present disclosure, the present disclosure adopts the following technical solution: A secondary battery, including

a cell, including a cell body, a first tab led out along one end of the cell body, and a second tab led out along the other end of the cell body; and

a connecting member, sleeved on the first tab and/or the second tab; and the connecting member includes a side surface welding portion which is arranged around the outer side surface of the first tab and/or the second tab and the side surface welding portion and the first tab and/or the second tab are connected by manner of welding.

Compared with a traditional connecting member, the connecting member of the present disclosure is provided on the outer side surface of the first tab and/or the second tab, and welding the first tab and/or the second tab to the connecting member from the outer side surface of the first tab and/or the second tab, the welding direction avoids the cell body, thereby avoiding damage to the cell body during welding, and improving the safety performance.

In an embodiment of the present disclosure, the connecting member further includes an end surface portion is located in an area surrounded by the side surface welding portion; the end surface portion includes an electrode terminal welding portion and a connecting part, the electrode terminal welding portion is connected to the side surface welding portion by means of the connecting part.

The end surface portion is a sealing flat surface connected to the side surface welding portion, and the electrode terminal welding portion and the connecting part are located on the flat surface; the end surface portion include the electrode terminal welding portion and the connecting part, a remaining part of the flat surface is hollow, and the electrode terminal welding portion achieves connection by means of the connecting part. The electrode terminal welding portion may be connected to a top cover or a bottom cover.

In an embodiment of the present disclosure, the electrode terminal welding portion is located at the center of the area surrounded by the side surface welding portion. The electrode terminal welding portion is arranged at the central position, which matches a situation in which an electrode terminal is provided at the center of an existing top cover or bottom cover.

In an embodiment of the present disclosure, the end surface portion includes a number of connecting parts, and a hollow part is provided between every two adjacent connecting parts of number of connecting parts. The arrangement of the hollow part may reduce the weight of the connecting member, prevent the connecting member from being too heavy, and also facilitate the electrolyte to permeant the cell passes through the hollow parts, thereby improving the permeability. The hollow part may be hole-shaped or sector-shaped, and when the hollow part is hole-shaped, the hollow part may serve as liquid injection, facilitating permeating by the electrolyte.

In an existing design, the second tab is connected to the housing, so that the housing carries second-polarity charges, and the first tab carries first-polarity charges; and when the connecting member above is applied, the inventor has further found that the side surface welding portion welded with the first tab carries first-polarity charges. As the side surface welding portion is in contact with a directly opposite part of the housing part, there is a risk of short circuit; and considering that the existing cell body and the housing are in close contact, only the relationship between the radius of the first tab, the thickness of the side surface welding portion and the radius of the cell body needs to be controlled, which may prevent the side surface welding portion with the first-polarity charges from contacting the housing with the second-polarity charges, thereby causing a short circuit. Therefore, the radius A1 of the first tab, the radius A2 of the cell body, and the thickness of the side surface welding portion are constructed to satisfy the following relational expression:

A2−A1>D1.

The cell is formed by winding a long current collector, as shown in FIG. 5, when the long current collector is unfolded, along the width direction of the long current collector, a head part and a tail part of the long current collector are respectively die-cut to cut away some parts, the remaining head part forms the first tab, and the remaining tail part forms the second tab; and the long current collector, after die-cutting, is wound to form the cell, the first tab forms a cylinder, the second tab forms a cylinder, and a middle part of the first tab and the second tab is a cylinder formed by the cell body.

Upon a large number of experiments, the inventor has found that: A2−A1−D1>4 mm, which may ensure that in a subsequent use process, the side surface welding portion with first-polarity charges do not contact the housing with second-polarity charges.

In an embodiment of the present disclosure, the secondary battery at least satisfies one of the following relational expressions:
(1) the length H1 of the first tab (11) and the height H3 of the side surface welding portion (21) satisfy a relational expression: H1−H3>d1, where d1 is a reserved gap, and d1 is 1 mm; and
(2) the length H2 of the second tab (12) and the height H3 of the side surface welding portion (21) satisfy a relational expression: H2−H3>d2, where d2 is a reserved gap, and d2 is 1 mm.

After the connecting member is sleeved on the first tab and the second tab, the height H3 of the side surface welding portion is smaller than the length H1 of the first tab, thereby preventing the side surface welding portion from contacting the cell body and improving safety performance. By the same reasoning, the height H3 of the side surface welding portion is smaller than the length H2 of the second tab, thereby preventing the side surface welding portion from contacting the cell body and improving safety performance. The first tab and the second tab are obtained by a flattening treatment, and the first tab and the second tab are tabs that have been flattened, and the length of the first tab and the second tab are the length that has been flattened.

In an embodiment of the present disclosure, an included angle α is formed between the side surface welding portion and an extension direction of the first tab and/or the second tab, and the included angle α is less than 10°. The side surface welding portion is provided with a certain inclination, so that the side surface welding portion forms an included angle α with an extension direction of the first tab and/or the second tab. After the connecting member is assembled, the side surface welding portion and the first tab and/or the second tab are more closely attached, thereby improving the welding firmness.

In an embodiment, the side surface welding portion is provided with at least two circles of welding sites. The provision of multiple welding sites may improve the welding firmness, thereby improving the safety performance.

In an embodiment of the present disclosure, the thickness of the side surface welding portion is 1-3 mm. In some embodiments, the thickness of the side surface welding portion is 1 mm, 1.5 mm, 1.8 mm, 2 mm, 2.5 mm, 2.8 mm and 3 mm.

A second object of the present disclosure is to provide an electric device with good safety.

In an embodiment of the present disclosure, the present disclosure adopts the following technical solution:

an electric device, including the secondary battery above.

Compared with the related art, a beneficial effects of the present disclosure lie in that: the secondary battery of the present disclosure is provided with a connecting member, the connecting member is provided with a side surface welding portion around the outer side of the first tab and/or the second tab, the connecting member is welded to the first tab and/or the second tab from the outer side of the side surface welding portion; and since a welding direction is a horizontal direction, a cell in a vertical direction is avoided, thereby protecting the cell and preventing a failure of the cell.

### BRIEF DESCRIPTION OF THE DRAWINGS

FIG. 1 is a schematic structural diagram of a secondary battery of the present disclosure.

FIG. 2 is a schematic diagram of assembling a cell and a connecting member.

FIG. 3 is a schematic structural diagram of a connecting member of the present disclosure.

FIG. 4 is another schematic structural diagram of a connecting member of the present disclosure.

FIG. 5 is a schematic die-cut diagram of a connecting member.

In which: 1. Cell; 11. First tab; 12. Second tab; 2. Connecting member; 21. Side surface welding portion; 22. End surface portion; 221. Electrode terminal welding portion; 222. Connecting part.

### DETAILED DESCRIPTION OF THE INVENTION

In an embodiment of the present disclosure, certain terms are used in the description and claims to refer to specific assemblies. A person skilled in the art would understand that hardware manufacturers may refer to the same assembly by using different nouns. The present description and claims do not use differences in names as a manner for distinguishing assemblies, but use differences in functions of assemblies as a criterion for distinguishing. In an embodiment, the term “include” mentioned throughout the description and the claims is an open-ended term and should be interpreted as “including but not limited to”. “Approximately” refers to within an acceptable error range, and a person skilled in the art would have been able to solve the technical problem within a certain error range and substantially achieve the technical effect.

In the illustration of the present disclosure, it should be understood that orientation or positional relationships indicated by terms such as “upper”, “lower”, “front”, “rear”, “left”, “right”, “horizontal” etc. are orientation or positional relationships based on those as shown in the accompanying drawings, are only used to facilitate the illustration of the present disclosure and to simplify the illustration, rather than indicating or implying that a device or element referred to must have a specific orientation, and be constructed and operated in the specific orientation, and therefore said terms cannot be understood as limitation to the present disclosure.

In the present disclosure, unless specified and limited otherwise, the terms “mount”, “connect to”, “connecting” and “fix”, etc. should be understood broadly, and in an embodiment, may be fixed connection, and may also be detachable connection, or integral connection; may be mechanical connection, and may also be electrical connection; and may be direct connection, and may also be indirect connection by means of an intermediate medium, and may also be interior communication between two elements. For a person of ordinary skill in the art, the specific meanings of the described terms in the present disclosure could be understood according to specific situations.

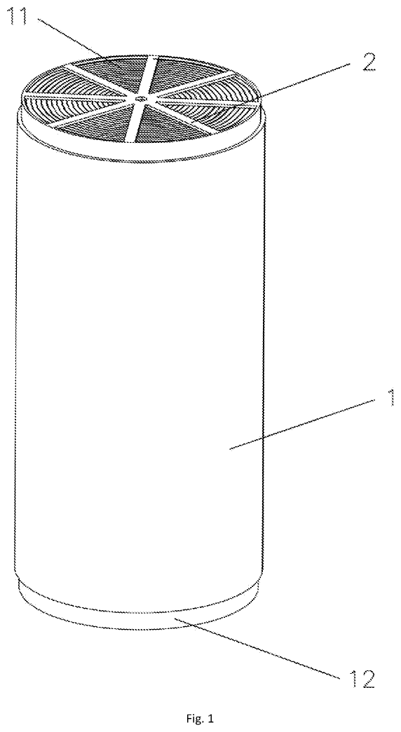

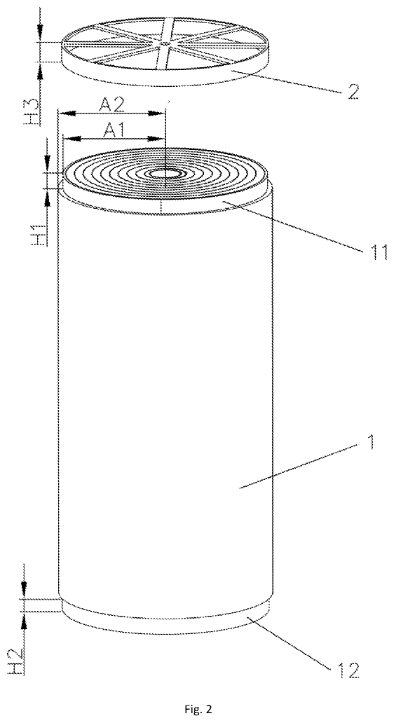

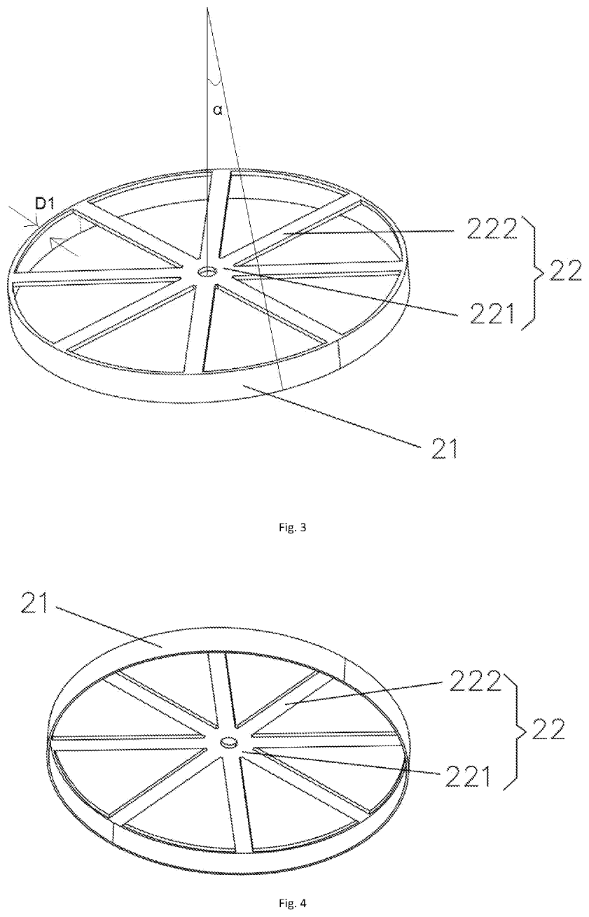

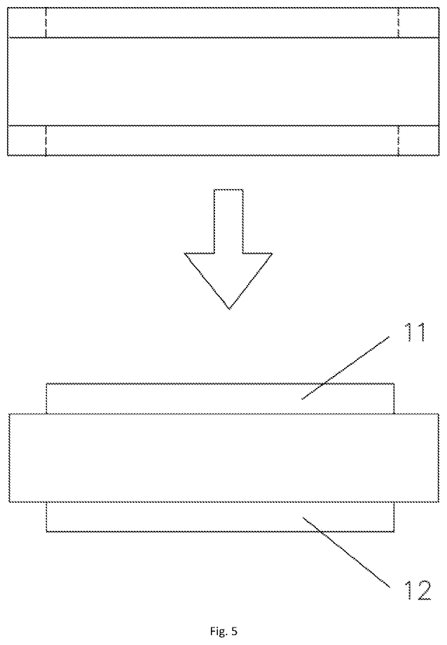

Hereinafter, the present disclosure will be further described in detail in conjunction with the FIGS. 1-5, but the illustration does not serve as a definition to the present disclosure.

### Embodiment I

A secondary battery, refer to FIGS. 1-5, includes:
a cell 1, including a cell body, a first tab 11 led out along one end of the cell body, and a second tab 12 led out along the other end of the cell body; and
a connecting member 2, sleeved on the first tab 11 and/or the second tab 12; and the connecting member 2 includes a side surface welding portion 21 which is arranged around the outer side surface of first tab 11 and/or the second tab 12, and the side surface welding portion 21 and the first tab 11 and/or the second tab 12 are connected by manner of welding.

Compared with a traditional connecting member, the connecting member of the present disclosure is provided on the outer side surface of the first tab 11 and/or the second tab 12, and welding the first tab 11 and/or the second tab 12 to the connecting member 2 from the outer side surface of the first tab 11 and/or the second tab 12, the welding direction avoids the cell body, thereby avoiding damage to the cell body during welding, and improving the safety performance.

In an embodiment of the present disclosure, the secondary battery includes a positive electrode plate, a separator and a negative electrode plate, and the first tab 11 is led out from the positive electrode plate, and the second tab 12 is led out from the negative electrode plate. The connecting member 2 is sleeved on the outer side surface of the first tab 11 and/or the second tab 12, and the thickness of the side surface welding portion 21 is 0.8 mm.

The positive electrode plate includes a positive electrode current collector and a positive active material layer provided on at least one surface of surfaces of the positive electrode current collector, the positive active material layer includes a positive active material; and the positive active material include but is not limited to combinations of one or more of compounds as shown in chemical formula such as LiₐNiₓCo_{y}M₂O_{2-b}N_{b} (where 0.95≤a≤1.2, x>0, y≥0, z≥0, x+y+z=1, 0≤b≤1, M is selected from one or a combination of more of Mn and Al, and N is selected from one or a combination of more of F, P and S). The positive active material may also be but is not limited to one or a combination of more of LiCoO₂, LiNiO₂, LiVO₂, LiCrO₂, LiMn₂O₄, LiCoMnO₄, Li₂NiMn₃O₈, LiNi_{0.5}Mn_{1.5}O₄, LiCoPO₄, LiMnPO₄, LiFePO₄, LiNiPO₄, LiCOFSO₄, CuS₂, FeS₂, MoS₂, NiS, TiS₂ and the like. The positive active material may also be subjected to a modification treatment. Methods for performing modification treatment on the positive active material would have been known to a person skilled in the art, in an embodiment, the positive active material may be modified by coating, doping, etc.; and materials used in the modification treatment include but are limited to one or a combination of more of Al, B, P, Zr, Si, Ti, Ge, Sn, Mg, Ce, W, etc. Moreover, the positive electrode current collector is generally a current collecting structure or part, the positive electrode current collector may be any material suitable for being used as a positive electrode current collector of a lithium ion battery in the art. In an embodiment, the positive electrode current collector may be include but is not limited to, a metal foil, and more specifically, may be include but is not limited to, an aluminum foil. The first tab 11 is led out from the positive electrode plate.

The negative electrode plate includes a negative electrode current collector and a negative active material layer arranged on the surface of the negative electrode current collector, the negative active material layer includes a negative active material; the negative active material include but is not limited to one or more of graphite, soft carbon, hard carbon, carbon fiber, mesocarbon microbeads, a silicon-based material, a tin-based material, lithium titanate or other metals capable of forming an alloy with lithium. The graphite may be selected from one or more of artificial graphite, natural graphite and modified graphite; the silicon-based material may be selected from one or more of elementary silicon, a silicon-oxygen compound, a silicon-carbon composite and a silicon alloy; and the tin-based material may be selected from one or more of elementary tin, a tin oxide compound and a tin alloy. The negative electrode current collector is generally a current collecting structure or part, the negative electrode current collector may be any material suitable for being used as a negative electrode current collector of a lithium ion battery in the art. In an embodiment, the negative electrode current collector include but is not limited to, a metal foil, and more specifically, may be include but is not limited to, a copper foil. The second tab 12 is led out from the negative electrode plate.

The separator is any material suitable for a separator of a lithium ion battery in the art, in an embodiment, the separator include but is not limited to one or a combination of more of polyethylene, polypropylene, polyvinylidene fluoride, aramid, polyethylene terephthalate, polytetrafluoroethylene, polyacrylonitrile, polyimide, polyamide, polyester, and natural fiber, etc.

The secondary battery also includes an electrolyte and a housing; the electrolyte includes an organic solvent, an electrolyte lithium salt and an additive. The electrolyte lithium salt may be LiPF₆ and/or LiBOB used in a high-temperature electrolyte; may also be at least one of LiBF₄, LiBOB and LiPF₆ used in a low-temperature electrolyte; may also be at least one of LiBF₄, LiBOB, LiPF₆ and LiTFSI used in an overcharge-prevention electrolyte; and may also be at least one of LiClO₄, LiAsF₆, LiCF₃SO₃ and LiN(CF₃SO₂)₂. In addition, the organic solvent may be cyclic carbonate, including PC and EC; may also be a chain carbonate, including DFC, DMC, or EMC; and may also be a carboxylic ester, including MF, MA, EA, MP etc. Moreover, the additive includes but is not limited to at least one of a film-forming additive, a conductive additive, a flame retardant additive, an overcharge-prevention additive, an additive for controlling contents of H₂O and HF in the electrolyte, an additive for improving low-temperature performance, and a multi-functional additive. The material of the housing may be one of aluminum plastic film and stainless steel.

The connecting member 2 further includes an end surface portion 22 is located in an area surrounded by the side surface welding portion 21; the end surface portion 22 includes an electrode terminal welding portion 221 and a connecting parts 222, the electrode terminal welding portion 221 is connected to the side surface welding portion 21 by means of the connecting parts 222.

The end surface portion 22 is a sealing flat surface connected to the side surface welding portion 21, and the electrode terminal welding portion 221 and the connecting part 222 are located on the flat surface; the end surface portion 22 includes the electrode terminal welding portion 221 and the connecting part 222, a remaining part of the flat surface is hollow, and the electrode terminal welding portion 221 achieves connection by means of the connecting part 222. The electrode terminal welding portion 221 is connected to a top cover or a bottom cover.

The electrode terminal welding portion 221 is located at the center of the area surrounded by the side surface welding portion 21. The electrode terminal welding portion 221 is arranged at the central position, which matches a situation in which an electrode terminal is provided at the center of an existing top cover or bottom cover.

The end surface portion 22 includes a number of connecting parts 222, and a hollow part is provided between every two adjacent connecting part 222 of the number of connecting parts 222. The arrangement of the hollow part may reduce the weight of the connecting member 2, prevent the connecting member 2 from being too heavy, and also facilitate the electrolyte to permeant the cell passes through the hollow part, thereby improving the permeability. The hollow part may be hole-shaped or sector-shaped, and when the hollow part is hole-shaped, the hollow part serves as liquid injection, facilitating permeating by the electrolyte.

In an existing design, the second tab 12 is connected to the housing, so that the housing carries second-polarity charges, and the first tab 11 carries first-polarity charges; and when the connecting member 2 above is applied, the inventor has further found that the side surface welding portion 21 welded with the first tab 11 carries first-polarity charges. As the side surface welding portion 21 is in contact with a directly opposite part of the housing part, there is a risk of short circuit; and considering that the existing cell body and the housing are in close contact, only the relationship between the radius of the first tab 11, the thickness of the side surface welding portion 21 and the radius of the cell body needs to be controlled, which may prevent the side surface welding portion 21 with the first-polarity charges from contacting the housing with the second-polarity charges, thereby causing a short circuit. Therefore, the radius A1 of the first tab 11, the radius A2 of the cell body, and the thickness of the side surface welding portion 21 are constructed to satisfy the following relational expression:

A2−A1>D1.

The cell 1 is formed by winding a long current collector, as shown in FIG. 5, when the long current collector is unfolded, along the width direction of the long current collector, a head part and a tail part of the long current collector are respectively die-cut to cut away some parts, the remaining head part forms the first tab, and the remaining tail part forms the second tab 12; and the long current collector, after die-cutting, is wound to form the cell 1, the first tab 11 forms a cylinder, the second tab 12 forms a cylinder, and a middle part of the first tab 11 and the second tab 12 is a cylinder formed by the cell body.

Upon a large number of experiments, the inventor has found that: A2−A1−D1>4 mm, which is able to ensure that in a subsequent use process, the side surface welding portion 21 with first-polarity charges do not contact the housing with second-polarity charges.

The secondary battery at least satisfies one of the following relational expressions:
(1) the length H1 of the first tab (11) and the height H3 of the side surface welding portion (21) satisfy the relational expression: H1-H3>d1, where d1 is a reserved gap, and d1 is 1 mm; and
(2) the length H2 of the second tab (12) and the height H3 of the side surface welding portion (21) satisfy the relational expression: H2-H3>d2, where d2 is a reserved gap, and d2 is 1 mm.

After the connecting member 2 is sleeved on the first tab 11 and the second tab 12, the height H3 of the side surface welding portion 21 is smaller than the length H1 of the first tab 11, thereby preventing the side surface welding portion 21 from contacting the cell body and improving safety performance. By the same reasoning, the height H3 of the side surface welding portion 21 is smaller than the length H2 of the second tab 12, thereby preventing the side surface welding portion 21 from contacting the cell body and improving safety performance. The first tab 11 and the second tab 12 are obtained by a flattening treatment, and the first tab 11 and the second tab 12 are tabs that have been flattened, and the length of first tab 11 and the second tab 12 are the length that has been flattened.

An included angle α is formed between the side surface welding portion 21 and an extension direction of the first tab 11 and/or the second tab 12, and the included angle α is less than 10°. The side surface welding portion 21 is provided with a certain inclination, so that the side surface welding portion 21 forms an included angle α with an extension direction of the first tab 11 and/or the second tab 12. After the connecting member 2 is assembled, the side surface welding portion 21 and the first tab 11 and/or the second tab 12 are more closely attached, thereby improving the welding firmness.

In an embodiment, the side surface welding portion 21 is provided with at least two circles of welding sites. The provision of multiple welding sites may improve the welding firmness, thereby improving the safety performance.

The thickness of the side surface welding portion 21 is 1-3 mm. In some embodiments, the thickness of the side surface welding portion 21 is 1 mm, 1.5 mm, 1.8 mm, 2 mm, 2.5 mm, 2.8 mm and 3 mm.

### Embodiment II

An electric device, the electric device includes a secondary battery described in Embodiment I. The electric device of the present disclosure includes but is not limited to, a notebook computer, a pen-input computer, a mobile computer, an e-book player, a portable telephone, a portable fax machine, a portable copy machine, a portable printer, a head-mounted stereo headphone, a video recorder, a liquid crystal television, a handheld cleaner, a portable CD machine, a mini disk, a transceiver, an electronic notepad, a calculator, a memory card, a portable sound recorder, a radio receiver, a backup power supply, a motor, an electric vehicle, an electric motorcycle, a power-assisted bicycle, a lighting appliance, a toy, a game console, an electronic clock, an electric tool, a flashlight, a camera, etc.

The illustration above shows and describes several preferred embodiments of the present disclosure, but as stated above, it should be understood that the present disclosure is not limited to the forms disclosed herein, and should not be considered as exclusion of other embodiments, but may be used in various other combinations, modifications and environments, and is able to be changed within the scope of concept of the present disclosure described herein by means of the teaching or technologies or knowledge in related fields. In addition, change and variation made by a person skilled in the art without departing from the spirit and scope of the present disclosure shall belong to the scope of protection of the appended claims of the present disclosure.

1. A secondary battery, comprising:
a cell, comprising a cell body, a first tab led out along one end of the cell body, and a second tab led out along the other end of the cell body, and polarities of the first tab and the second tab are opposite; and
a connecting member, comprising a side surface welding portion, and the side surface welding portion is arranged around an outer side surface of the first tab and/or the second tab, and the side surface welding portion and the first tab and/or the second tab are connected by manner of welding.

2. The secondary battery according to claim 1, wherein the connecting member further comprises an end surface portion, the end surface portion is located in an area surrounded by the side surface welding portion; the end surface portion comprises an electrode terminal welding portion and a connecting part, the electrode terminal welding portion is connected to the side surface welding portion by means of the connecting part.

3. The secondary battery according to claim 2, wherein the electrode terminal welding portion is located at the center of the end surface portion.

4. The secondary battery according to claim 2, wherein the end surface portion comprises a number of connecting parts, and a hollow part is provided between every two adjacent connecting parts of the number of connecting parts.

5. The secondary battery according to claim 1, wherein the secondary battery satisfies a following relational expression: A2−A1>D1, and A1 is a radius of the first tab, A2 is a radius of the cell body, and D1 is the thickness of the side surface welding portion.

6. The secondary battery according to claim 5, wherein the secondary battery satisfies the following relational expression: A2−A1−D1>4 mm, the unit of A1, A2, D1 being mm.

7. The secondary battery according to claim 1, wherein the secondary battery satisfies the following relational expression:
the length H1 of the first tab and the height H3 of the side surface welding portion satisfy a relational expression: H1−H3>d1, where d1 is a reserved gap, and d1 is 1 mm.

8. The secondary battery according to claim 1, wherein an included angle α is formed between the side surface welding portion and an extension direction of the first tab and/or the second tab, and the included angle α is less than 10°.

9. The secondary battery according to claim 1, wherein the thickness of the side surface welding portion is 1-3 mm.

10. An electric device, comprising the secondary battery according to claim 1.

11. The secondary battery according to claim 1, wherein the secondary battery satisfies the following relational expression:
the length H2 of the second tab and the height H3 of the side surface welding portion satisfy a relational expression: H2−H3>d2, where d2 is a reserved gap, and d2 is 1 mm.

12. The secondary battery according to claim 6, wherein the secondary battery satisfies the following relational expression:
the length H1 of the first tab and the height H3 of the side surface welding portion satisfy a relational expression: H1−H3>d1, where d1 is a reserved gap, and d1 is 1 mm.

13. The secondary battery according to claim 6, wherein the secondary battery satisfies the following relational expression:
the length H2 of the second tab and the height H3 of the side surface welding portion satisfy a relational expression: H2−H3>d2, where d2 is a reserved gap, and d2 is 1 mm.

14. The secondary battery according to claim 2, wherein the end surface portion is a sealing flat surface connected to the side surface welding portion.

15. The secondary battery according to claim 1, wherein the side surface welding portion is provided with at least two circles of welding sites, and the provision of multiple welding sites may improve the welding firmness.

16. The secondary battery according to claim 1, wherein the secondary battery comprises a positive electrode plate, a separator and a negative electrode plate, and the first tab is led out from the positive electrode plate, and the second tab is led out from the negative electrode plate.
